(19) United States
(12) Patent Application Publication
(10) Pub. No.: US 2009/0148182 A1
(43) Pub. Date: Jun. 11, 2009

(54) IMAGE HOLDING MEMBER, IMAGE FORMING APPARATUS, AND CHARGING MEMBER FOR IMAGE FORMING APPARATUS

(75) Inventors: Takeshi Watanabe, Kanagawa (JP); Masashi Takahashi, Kanagawa (JP); Mitsuaki Kouyama, Tokyo (JP)

Correspondence Address: AMIN, TUROCY & CALVIN, LLP, 127 Public Square, 57th Floor, Key Tower, CLEVELAND, OH, 44114, US

(73) Assignees: KABUSHIKI KAISHA TOSHIBA, Tokyo (JP); TOSHIBA TEC KABUSHIKI KAISHA, Tokyo (JP)

(21) Appl. No.: 12/326,513

(22) Filed: Dec. 2, 2008

Related U.S. Application Data
(60) Provisional application No. 60/992,937, filed on Dec. 6, 2007.

(51) Int. Cl. G03G 15/00

(52) U.S. Cl. 399/159; 524/440

(57) ABSTRACT

An image bearing member that holds an image according to one aspect of the invention contains noble metal nanoparticles dispersed in at least a surface of a resin layer of the image bearing member.

### CROSS-REFERENCE TO RELATED APPLICATION

This application claims the benefit of priority of co-pending U.S. Provisional Patent Application No. 60/992,937 filed on Dec. 6, 2007, the entire disclosures of which are incorporated herein by reference.

### TECHNICAL FIELD

The present invention relates to an image bearing member, such as a photoreceptor, which is charged on the surface thereof, an image forming apparatus, a charging member for an image forming apparatus, and the like.

### BACKGROUND

It is known that an image bearing member used for electrophotography and electrostatic recording is oxidized with ozone generated from a charging device or contaminated by deterioration with a product formed through reaction of ozone and an organic matter in the air, thereby causing problems including image blur.

Accordingly, such measures are conventionally employed that an ozone absorbing filter is used, the surface of an image bearing member is chipped away by a cleaning blade little by little, and the like.

It is also known to use a material that is hard to be oxidized with ozone on the surface of an image bearing member (see JP-A-7-128892). However, there is no material that sufficiently prevents oxidation with ozone by using on the image bearing member, such as a photoreceptor, under the current situation, which is a major impediment on extending the service life of an image bearing member.

As another measures for removing ozone generated in a charging device, it is known that ozone is decomposed with a photocatalyst, such as titanium oxide (see JP-A-2001-235888).

In a device using the method, however, it is not effective since an exciting light source for radiating light containing an ultraviolet ray is necessarily used to exhibit the photocatalyst function, whereby the cost of equipments is increased, and such a problem arises that the resin layer of the image bearing member is deteriorated with the ultraviolet ray.

Under the circumstances, for attaining a photoreceptor having high durability, such attempts are frequently made that the surface of the image bearing member is subjected to a hardening treatment with an ultraviolet ray, an electron beam, a radiation ray or the like, thereby prolonging the service life by decreasing abrasion. According to the treatment, however, a contaminated surface is not abraded to induce formation of image blur, which bring about problems of reducing the service life and the like.

A contact charging device and a proximity charging device are often employed as an ozone-less charging device for reducing the amount of ozone generated in the charging device. In the charging device, however, discharge is generated concentratedly in a contact part or a proximity part with the image bearing member to generate high-concentration ozone locally. As a result, deterioration of the charging member and the photoreceptor with ozone becomes conspicuous as compared to a corona discharge device.

### SUMMARY

The invention is made in view of the problems due to generation of ozone in the conventional charging device, and is to provide an image bearing member, an image forming apparatus and a charging member for image forming apparatus that does not use a material that is hard to be oxidized with ozone on the surface of the image bearing member, and needs no irradiation of the photoreceptor with an ultraviolet ray or the like, thereby suppressing generation of ozone.

According to one aspect of the invention, an image bearing member that holds an image is provided that contains noble metal nanoparticles dispersed in at least a surface of a resin layer of the image bearing member.

### DESCRIPTION OF THE DRAWINGS

FIG. 1 is a graph showing spectral sensitivity characteristics of a phthalocyanine photoreceptor and an azo photoreceptor in the case where gold (Au) particles are dispersed and the case where the particles are not dispersed.

FIG. 2 is a diagram showing a structure of an image forming apparatus.

FIG. 3 is a diagram showing a structure of an experimental apparatus used for investigating the presence of the ozone decomposition effect in the invention.

FIG. 4 is a table showing evaluation results of image blur and halftone unevenness of samples of organic photoreceptor for investigating the effect where noble metal nanoparticles or the like are dispersed in the photoreceptor in the examples of the invention.

FIG. 5 is a diagram showing a structure of an image forming apparatus of a cleanerless process used in the examples of the invention.

FIG. 6 is a table showing evaluation results of image blur and halftone unevenness of samples of organic photoreceptor for investigating the effect where noble metal nanoparticles or the like are dispersed in a charging roller in the examples of the invention.

FIG. 7 is a table showing evaluation results of image blur and halftone unevenness of samples of organic photoreceptor for investigating the effect where an α-Si photoreceptor or a hardened photoreceptor is used as a photoreceptor, and noble metal nanoparticles or the like are dispersed in a contact charging roller in the examples of the invention.

FIG. 8 is a table showing evaluation results of image blur and halftone unevenness of samples of organic photoreceptor for investigating the effect where a hardened photoreceptor is used as a photoreceptor, and noble metal nanoparticles or the like are dispersed in a non-contact charging roller in the examples of the invention.

### DETAILED DESCRIPTION

Embodiments of an image forming apparatus according to the invention will be described with reference to the drawings.

### Production of Photoreceptor

In the invention, it is not necessary to irradiate a photoreceptor with an ultraviolet ray or the like, and thus an organic photoreceptor (OPC) can be used.

The production method of an organic photoreceptor is known, and for example, a production example of an organic photoreceptor enhanced in durability by dispersing a metallic oxide is disclosed in JP-A-2002-341571.

In the invention, description of the basic production method thereof is omitted since it contains a conventional example disclosed in JP-A-2002-341571, and the advantage thereof is verified by using the following combinations of a metallic oxide and noble metal nanoparticles added to the resin surface layer.

The organic photoreceptor (OPC) used was a phthalocyanine laminated photoreceptor or an azo laminated photoreceptor having a diameter of 30 mm produced by Yamanashi Electronics Co., Ltd., on which the following surface layer was coated with a dipping device.

According to JP-A-2002-341571, the CTL (charge transporting layer) is dissolved by dipping to cause coating unevenness. In this example, the film thickness was controlled to 5 μm by changing the conditions.

The following 8 samples of organic photoreceptors were produced. OPC8 is sample of a conventional organic photoreceptor containing no fine particle.
OPC1: A surface layer having 5% of gold (Au) fine particles dispersed in polycarbonate was coated.
OPC2: A surface layer having 5% of platinum (Pt) fine particles dispersed in polycarbonate was coated.
OPC3: A surface having 20% of titanium oxide (TiO₂) particles having gold (Au) fine particles attached thereto in advance (5% by weight of Au fine particles based on TiO₂) dispersed in polycarbonate was coated.
OPC4: A surface having 20% of iron oxide (FeO₃) particles having gold (Au) fine particles attached thereto in advance (7% by weight of Au fine particles based on FeO₃) dispersed in polycarbonate was coated.
OPC5: A surface having 20% of titanium oxide (TiO₂) particles having platinum (Pt) fine particles attached thereto in advance (5% by weight of Pt fine particles based on TiO₂) dispersed in polycarbonate was coated.
OPC6: A surface having 20% of iron oxide (FeO₃) particles having platinum (Pt) fine particles attached thereto in advance (7% by weight of Pt fine particles based on FeO₃) dispersed in polycarbonate was coated.
OPC7: A surface having only 20% of titanium oxide (TiO₂) particles dispersed in polycarbonate was coated.
OPC8: A surface layer containing only polycarbonate but containing no noble metal fine particle was coated.

Titanium oxide or iron oxide having too large a particle diameter adversely affects the exposed image since it is used in the surface layer of the photoreceptor. A diameter thereof of 200 nm or less causes no large problem on the image, and the particle diameter of titanium oxide or iron oxide is preferably about from 10 to 200 nm.

The noble metal nanoparticles are preferably smaller than the metallic oxide that is simultaneously used therewith. All the noble metal nanoparticles used in the experiments had a particle diameter of about 5 nm.

The particle diameter was measured by sampling arbitrary 50 particles on several sheets of enlarged photographs obtained with an electron microscope, and the maximum diameters of the particles were measured by digitizing the images, followed by averaging. As for the gold particles and the platinum particles, about 100 particles were sampled from the images, and the maximum diameters were averaged.

### Production Method of Gold Nanoparticles

The production method of the gold nanoparticles may be the method disclosed in JP-A-2004-244433 or the like, and is described in detail in Hyomen Kagaku Gakkai-shi (Journal of the Surface Science Society of Japan), vol. 26, No. 10, pp. 578-584 (2005). In the invention, those produced according to the later method were used. Platinum nanoparticles can be produced in substantially the same manner.

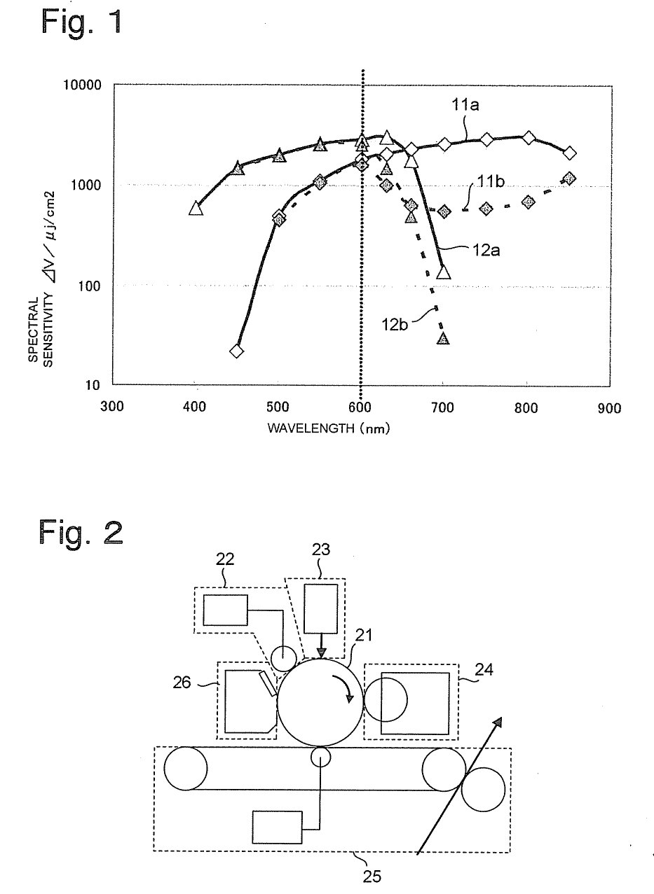

Noble metal nanoparticles, such as gold nanoparticles, has a tendency of becoming reddish upon dispersing, and for example, the aforementioned photoreceptor sample 1 has the spectral sensitivity characteristics shown in FIG. 1. In FIG. 1, the abscissa shows the wavelength (nm), and the ordinate shows the spectral sensitivity (ΔV/μj/cm²). In FIG. 1, the characteristic curve 11a shows a conventional case using a phthalocyanine laminated photoreceptor without gold (Au) particles, and the characteristic curve 11b shows a case using a phthalocyanine laminated photoreceptor with gold particles added to the surface layer. The characteristic curve 12a shows a conventional case using an azo laminated photoreceptor without gold particles, and the characteristic curve 12b shows a case using an azo laminated photoreceptor with gold particles added to the surface layer.

It is understood from the spectral sensitivity characteristics shown in FIG. 1 that the surface layer having noble metal nanoparticles dispersed therein decreases the sensitivity on the longer wavelength side of 600 nm or more, and thus an exposure wavelength of 600 nm or less is favorable in efficiency. It is also understood that the material for the photoreceptor is suitably a material represented by an azo series material having large absorption on the short wavelength side rather than a phthalocyanine series material having large absorption in a range of from red to infrared. Accordingly, in the invention, exposure is preferably performed with light having a wavelength of 600 nm or less, and an azo photoreceptor is preferably used.

The photoreceptor samples 1 to 7 thus produced are installed in the electrophotographic apparatus shown in FIG. 2 for printing images. In general, the surface of the photoreceptor is abraded in the cleaning part or the like, and even when the surface of the photoreceptor is chemically deteriorated with ozone, the surface is refaced repeatedly, thereby producing no problem on images just yet, although the film thickness is reduced.

However, if the photoreceptor is hard to be abraded for improving the durability thereof, the balance disrupted to provide influence of ozone deterioration on images, whereas if a photoreceptor that is liable to be abraded is used, it should be replaced in a short period due to abrasion on the surface.

In the invention, for confirming the presence of the ozone decomposition effect under the conditions where the photoreceptor is not abraded, charging and exposure are performed repeatedly, and the influence of ozone deterioration is compared. An ordinary image forming apparatus has, as shown in FIG. 2, a photoreceptor drum 21, around which a charging member 22, an exposing member 23, a developing member 24, a transferring member 25 and a cleaner member 26 are disposed in this order.

The image forming device has a rotatable photoreceptor drum 21, a charging member 22 that charges the organic photoreceptor, an exposing member 23 that selectively irradiates the organic photoreceptor, which is charged with the charging member 22, to form a latent image, a developing member 24 that develops the latent image, which is formed with the exposing member 23, with a toner, a transferring member 25 that transfers a toner image, which is developed with the developing member 24, to a carrier, and a cleaner member 26 that cleans the toner remaining after transferring the toner image with the transferring member 25.

According to the invention, for example, noble metal nanoparticles, or noble metal nanoparticles and a metallic oxide are dispersed at least a surface of a resin layer of the organic photoreceptor having the resin layer on the surface thereof.

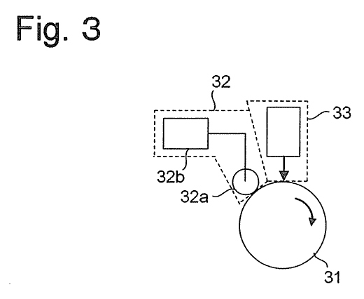

In this experiment, the developing member 24, the transferring member 25 and the cleaner member 26 were removed from the apparatus shown in FIG. 2 to form an apparatus shown in FIG. 3, in which only a charging member 32 and an exposing member 33 were disposed around a photoreceptor drum 31. The photoreceptor drum 31 was an azo photoreceptor, and the exposure was performed with short-wavelength laser light having a wavelength of 550 nm.

The beam diameter can be narrowed with a shorter wavelength, which is advantageous for providing a high resolution. In the invention, a thin photoreceptor can be used since the photoreceptor is not abraded without ozone deterioration, which is advantageous for providing a high resolution. Accordingly, the invention is suitable for providing a high resolution.

The charging member 32 contains a non-contact charging roller 32a disposed close to the photoreceptor drum 31, and a charging device 32b. The charging roller 32a is applied from the charging device 32b with a signal containing DC of 500 V having an AC bias of 1 kHz superimposed thereon, and is rotated at a speed that is substantially equal to the surface of the photoreceptor drum 31.

The charging roller 32a is a roller made with a resin having integrated on both ends thereof guide rollers having a diameter that is larger by 50 μm than the charging roller. Accordingly, the gap between the surface of the photoreceptor drum 31 and the surface of the charging roller 32a is maintained at about 25 μm.

After charging the surface of the photoreceptor drum 31 with the charging roller 32a, the entire surface of the photoreceptor drum 31 is irradiated with light in the exposing member 33. As a result, the charge potential on the photoreceptor is substantially erased, and then the photoreceptor drum 31 is rotated for charging again the surface of the photoreceptor drum 31 with the charging member 32. By using an experimental apparatus, the charge potential is then again erased by irradiating the surface of the photoreceptor drum 31 with light in the exposing member 33. The cycle of charging and exposing on the surface of the photoreceptor is repeated to investigate the extent of deterioration on the surface of the photoreceptor through generation of ozone and the like for the 8 samples of the organic photoreceptors.

The cycle of charging and exposure was performed for continuous printing for 5,000 sheets of A4 size, and then the photoreceptor was installed in the apparatus shown in FIG. 2 for printing images, which were compared with the images in the initial stage. After printing images for 5,000 sheets, the test was continued for another 5,000 sheets, and the test results for 10,000 sheets in total were also evaluated.

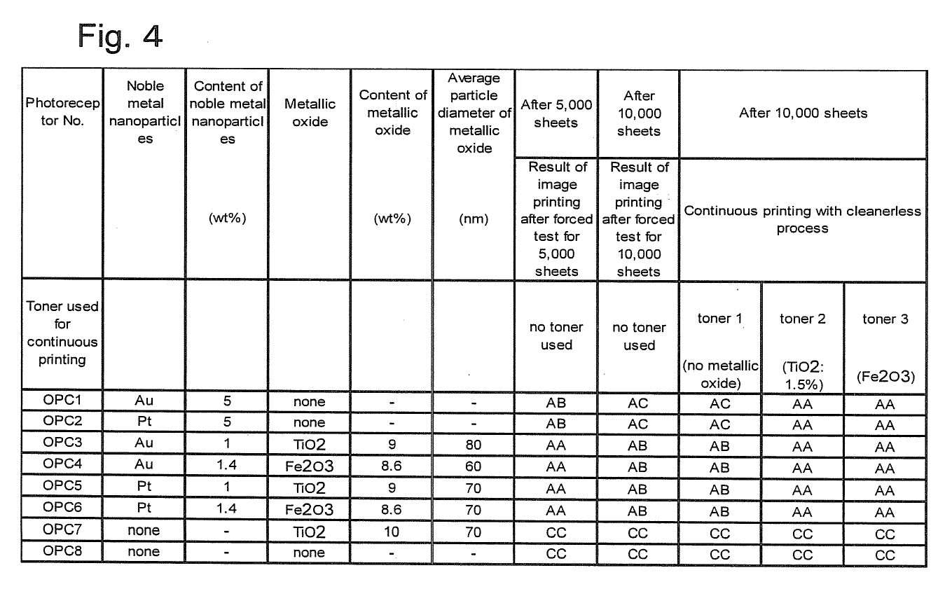

The results are shown in FIG. 4. FIG. 4 shows the results of the forced test corresponding to image output of 5,000 sheets, and the results of the forced test corresponding to image output of 10,000 sheets. FIG. 4 also shows the results of continuous printing by a cleanerless process with a toner 1 containing no metallic oxide, a toner 2 containing 1.5% of a metallic oxide (TiO₂) and a toner 3 containing a metallic oxide (Fe₂O₃), after the forced test corresponding to 10,000 sheets.

When the surface of the photoreceptor is deteriorated with a discharge product, such as ozone, image blur occurs, and unevenness occurs in a halftone image due to unstable increase of the potential after exposure, in many cases. In the table shown in FIG. 4, the test results of image blur and halftone are apposed.

In the evaluation of the image blur and the halftone, a state that can be clearly distinguished visually is evaluated as C, and a state that is substantially not changed from the initial stage is evaluated as A. For the evaluation of halftone, a level that is changed in density as compared to the initial stage but does not form image unevenness is evaluated as B.

According to the results shown in FIG. 4, OPC7 having only a metallic oxide dispersed and OPC8 having no material dispersed suffered image blur and halftone unevenness at the time of 5,000 sheets.

OPC1 and OPC2 having noble metal nanoparticles dispersed suffered no large problem that is peculiar to deterioration with ozone and NOₓ, such as image blur, although the halftone density is fluctuated from the initial stage (potential after exposure slightly increased).

OPC3 to OPC6 having further a metallic oxide dispersed in combination suffered no change from the initial stage to provide favorable images.

In the results after 10,000 sheets, OPC1 and OPC2 suffered halftone unevenness but still suffer no image blur, and OPC3 to OPC6 provided favorable images.

As described herein, the sole use of noble metal nanoparticles is effective for preventing the surface of the photoreceptor from being deteriorated with a discharge product, such as ozone, and upon further mixing a metallic oxide, a larger advantage is obtained for preventing the surface of the photoreceptor from being deteriorated.

Experiment with Cleanerless Process

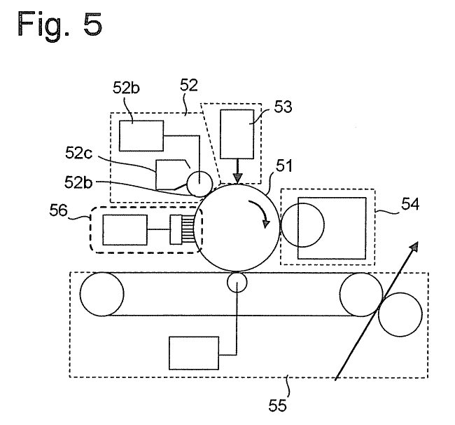

As another test method, a cleanerless process was employed as measures where the photoreceptor is not abraded. An example of a structure of an apparatus for the cleanerless process is shown in FIG. 5.

The apparatus has, as similar to the image forming apparatus shown in FIG. 2, a rotating photoreceptor drum 51, around which a charging member 52, an exposing member 53, a developing member 54 and a transferring member 55 are disposed in this order, but there is no cleaner member, and instead a member 56 for disturbing a toner remaining after transferring is provided. The charging member 52 has a charging roller 52a and a charging device 52b for charging the charging roller 52a, and also has a charging roller cleaner 52c for cleaning the charging roller 52a.

Accordingly, instead of an ordinary cleaning blade, the member 56 for disturbing a toner remaining after transferring is used, and when the transfer efficiency is good, no cleaning part is provided, and the surface of photoreceptor drum 51 can be inserted as it is to the charging member 52. As the member 56 for disturbing a toner remaining after transferring, a brush or a blade-like member is used.

The cleanerless process can be used in either a contact charging roller or corona charging, and a toner passing through the charging member is negatively charged and thus is recovered in the developing member 54.

However, when proximity roller charging or contact charging is used, it is important to use measures for preventing a charging member from being contaminated, and various examples for the measures are disclosed. In this experiment, such a structure is employed that a cleaner simply is provided on the proximity charging roller as shown in FIG. 5.

The cleanerless process cannot be performed unless a toner remaining after transferring passes through the charging member and the exposing member, and the transfer efficiency is nearly 100%. Accordingly, a toner having a high sphericity is used, and a structure without a disturbing brush for removing contamination on the surface of the photoreceptor (i.e., a structure of FIG. 5, from which the member 56 for disturbing a toner remaining after transferring is removed) is used for performing a continuous printing test.

In the results of the forced test only with the charging member 52 and the exposing member 53, it is confirmed that the influence of a discharge product, such as ozone, can be reduced when the noble metal particles are dispersed in the surface layer of the photoreceptor drum 51, and it is known that a larger effect can be obtained by combining the metallic oxide.

In this confirmation test, accordingly, a toner having a metallic oxide externally added thereto and a toner having no metallic oxide were tested for comparing as to whether or not an advantage is obtained by mixing a metallic oxide to a toner.

The toner used was a polyester pulverized toner subjected to a heat treatment, to which silica fine particles were appropriately added for charge controlling and adjustment of flowability. The average particle diameter thereof is about 6 μm, and the shape factor SF-1 is about from 110 to 120 for SF-1 and about from 110 to 130 for SF-2. The aforementioned metallic oxide, for example, titanium oxide or iron oxide having a diameter of 200 nm or less, which is larger than the noble metal nanoparticles, is further externally added.
Toner 1: No metallic oxide externally added
Toner 2: 1.5 wt % of TiO₂ externally added (particle diameter: about 80 nm)
Toner 3: 1.5 wt % of Fe₂O₃ externally added (particle diameter: about 70 nm)

In the continuous printing test, an image of A4 size with a printing ratio of 4% was printed, and the development was performed by two-component developing. The continuous printing test for 10,000 sheets was performed with the same bias conditions of the proximity charging roller as in the aforementioned test, and the photoreceptor was taken out and then installed in the image printing apparatus of FIG. 2 for confirming change in images from the initial stage as similar to the aforementioned test. The results are shown in FIG. 4.

It is understood from the table shown in FIG. 4 that the combination with the toner 1 provides substantially the same results as the previous forced test of charging and exposing, whereas the combination of the toner 2 or the toner 3 provides results equivalent to OPC3 to OPC6 even though the photoreceptor having only the noble metal nanoparticles dispersed therein, such as OPC1 and OPC2, is used.

Accordingly, when the metallic oxide is externally added to the toner, the influence of a discharge product, such as ozone, on the photoreceptor can be significantly reduced through the effect of the combination with the noble metal nanoparticles dispersed in the surface layer of the photoreceptor.

Case where Noble Metal Nanoparticles are Dispersed in Charging Member

Subsequently, the case where noble metal nanoparticles are dispersed in the charging member but not in the photoreceptor is verified. Examples of the charging member include a contact charging roller. The charging roller may have a multilayer structure or a single layer structure, as far as it contains an elastic layer. It is important that the outermost layer, which is in contact with the photoreceptor, contains the noble metal nanoparticles.

Examples of the resin material include a fluorine resin, a polyamide resin, an acrylic resin, a polyurethane resin, a silicone resin, a butyral resin, a styrene-ethylene/butylene-olefin copolymer (SEBC), an olefin-ethylene/butylene-olefin copolymer (CEBC) and the like.

Examples of the elastomer include synthetic rubber and a thermoplastic elastomer, and examples of the synthetic rubber include natural rubber (such as vulcanized one and the like), epichlorohydrin rubber, EPDM, SBR, silicone rubber, urethane rubber, IR, BR, NBR, CR and the like.

Examples of the thermoplastic elastomer include a polyolefin thermoplastic elastomer, an urethane thermoplastic elastomer, a polystyrene thermoplastic elastomer, a fluorine rubber thermoplastic elastomer, a polyester thermoplastic elastomer, a polyamide thermoplastic elastomer, a polybutadiene thermoplastic elastomer, an ethylene-vinyl acetate thermoplastic elastomer, a polyvinyl chloride thermoplastic elastomer and a chlorinate polyethylene thermoplastic elastomer.

These materials may be used solely or as a mixture of two or more of them, or may be a copolymer. Electroconductivity can be controlled by appropriately adding an electroconductive agent, such as carbon black, an electroconductive metallic oxide, an alkali metal salt and an ammonium salt, to the aforementioned elastic materials.

The evaluation was performed by producing a single layer charging roller.

Epichlorohydrin rubber terpolymer (epichlorohydrin/ethylene oxide/allyl glycidyl ether=40 mol %/56 mol %/4 mol %): 100 parts by weight

Light calcium carbonate: 30 parts by mass

Aliphatic polyester plasticizer: 10 parts by mass

Quaternary ammonium salt: 2 parts by mass

Au nanoparticles (particle diameter: about 5 nm): 0 or 5 parts by mass

TiO₂ particles (particle diameter: about 80 nm): 0 or 10 parts by mass

Carbon black: 2 to 10 parts by mass

Samples containing the Au nanoparticles and the TiO₂ particles and not containing them were prepared, and the addition amount of the carbon black was adjusted in a range of from 2 to 10 parts by mass for controlling the resistance.

The materials were kneaded with a sealed mixer adjusted to 50° C. for 10 minutes to prepare a raw material compound.

1 part by mass of sulfur as a vulcanizing agent, 1 part by mass of DM (dibenzothiadisulfide) and 0.5 part by mass of TS (tetramethylthiurammonosulfide) as a vulcanizing accelerator per 100 parts by mass of the epichlorohydrin rubber as a raw material rubber were added to the compound, which was kneaded with two-roll machine cooled to 20° C. for 10 minutes. The resulting compound was molded on a stainless steel core metal having a diameter of 6 mm into a roller form having an outer diameter of 12 mm with an extrusion molding machine, and after vulcanizing with heated steam, the roller was ground by a wide-width grinding method to an outer diameter of 8.5 mm to provide an elastic layer. The length of the roller was 330 mm.

The following roller samples were produced by the aforementioned manner.
Roller 1: charging roller containing Au nanoparticles
Roller 2: charging roller containing Au nanoparticles and TiO₂ particles
Roller 3: charging roller containing TiO₂ particles
Roller 4: charging roller containing neither Au nor TiO₂

The following roller samples were similarly produced with platinum (Pt) and iron oxide (Fe₂O₃).
Roller 5: charging roller containing Pt nanoparticles and TiO₂ particles
Roller 6: charging roller containing Pt nanoparticles and Fe₂O₃ particles

The charging roller was made in contact with a photoreceptor, and the similar test as in the photoreceptor was performed.

In the test, the continuous operation of repeated charging and exposure was performed as similar to the case of evaluating the photoreceptor in the state where the developing member, the transferring member and the cleaner member were removed as shown in FIG. 3. After printing 5,000 sheets or 10,000 sheets, the test was performed in the case where images were printed with an image printing apparatus shown in FIG. 2, and in the case where the cleanerless process without a member for disturbing a toner remaining after transferring is performed with a charging roller cleaner provided for removing toner contamination on the charging roller.

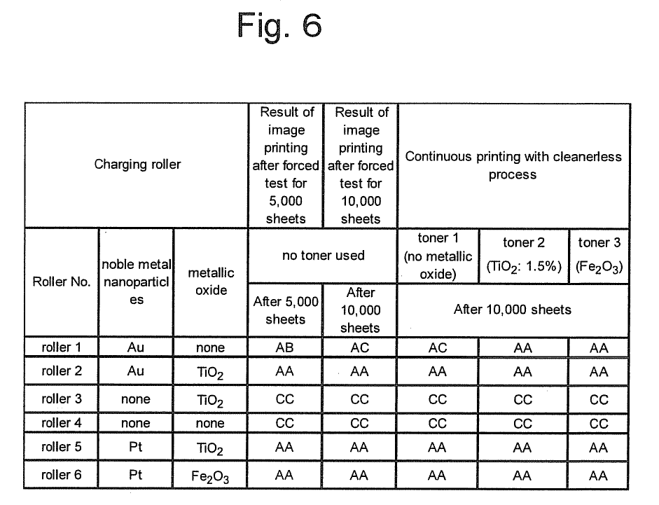

The charging roller was applied with DC of 500 V having an AC bias of pp 2,000 V and 1 kHz superimposed thereon, and was rotated by driven with the surface of the photoreceptor. The photoreceptor used was an azo organic photoreceptor. The results are shown in FIG. 6.

In the table shown in FIG. 6, the test results of image blur and halftone are apposed in this order.

In the evaluation of the image blur and the halftone, a state that can be clearly distinguished visually is evaluated as C, and a state that is substantially not changed from the initial stage is evaluated as A. For the evaluation of halftone, a level that is changed in density as compared to the initial stage but does not form image unevenness is evaluated as B.

It is understood from the results that when the noble metal nanoparticles are dispersed in the charging roller, a discharge product, such as ozone and NOₓ, is decomposed to eliminate image deformation, blur and the like, as similar to the case where the noble metal particles are dispersed in the photoreceptor.

When a metallic oxide is externally added to the toner, the decomposition capability of ozone and the like by the combination of the noble metal nanoparticles and the metallic oxide is enhanced only by dispersing the noble metal nanoparticles in the charging roller.

As described above, in the charging member for the photoreceptor, noble metal nanoparticles are added to a member contributing in the vicinity of the surface of the photoreceptor, whereby a discharge product, such as ozone, generated in the charging area can be decomposed, and image deterioration due to deterioration of the surface of the photoreceptor can be prevented even though the surface of the photoreceptor is substantially not abraded.

The advantage is obtained by dispersing the noble metal nanoparticles in the photoreceptor or the charging roller in the examples, but it can be easily expected that the advantage can be obtained for example when the particles are present as charging assistant particles or the like isolated in the vicinity of the charging member.

It is said that noble metal nanoparticles, particularly gold and platinum, do not have decomposition effect of ozone and the like owing to the chemical stability thereof. It is reported in recent years, however, that nanoparticles thereof function as a catalyst particularly in the interface with an oxide or the like. The material is applied to the charging process of electrophotography, whereby the problem that is difficult to be resolved conventionally, i.e., chemical deterioration due to ozone or the like is prevented without abrading the photoreceptor, can be resolved without large-scale measures associated with many problems, such as an ultraviolet ray or the like.

The invention is particularly effective when a photoreceptor that is hard to be abraded is used or when a cleanerless process is used, for enhancing durability.

As the photoreceptor that is hard to be abraded, for example, when a photoreceptor using an α-Si material, or as an organic photoreceptor, one containing a positive hole transporting material having a chain polymerizable functional group disclosed in JP-A-2005-173566 is used, the surface of the photoreceptor is increased in hardness and thus is hard to be damaged.

However, the photoreceptor is substantially not abraded by using a cleaning blade, whereby deterioration on the surface of the photoreceptor with a discharge product, such as ozone and NOₓ, may become a serial problem, and therefore, the constitution of the invention is significantly effective for the case using the photoreceptor.

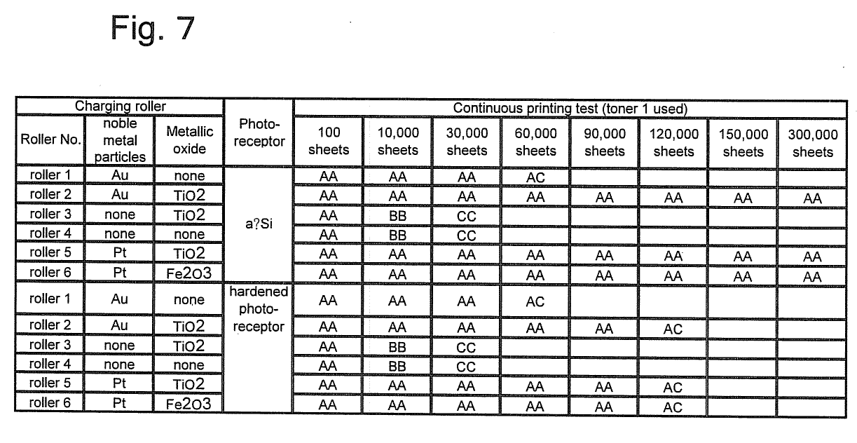

FIG. 7 shows the results of a continuous printing test actually performed with the photoreceptor that is hard to be abraded, in which an image of A4 size with a printing ratio of 4% was printed. In an ordinary image forming apparatus, the vicinity of the charging member is aspirated with a fan or the like to prevent substances, such as ozone, from accumulating, but this experiment is performed without a fan.

In the table shown in FIG. 7, the test results of image blur and halftone are apposed in this order.

In the evaluation of the image blur and the halftone, a state that can be clearly distinguished visually is evaluated as C, and a state that is substantially not changed from the initial stage is evaluated as A. For the evaluation of halftone, a level that is changed in density as compared to the initial stage but does not form image unevenness is evaluated as B.

In the test, as the α-Si photoreceptor, a product available from Kyocera Corporation was used, and as the hardened organic photoreceptor, the aforementioned organic photoreceptor was used.

According to the results, the metallic nanoparticles were added to the surface of the charging roller, whereby a problem of image blur with ozone was resolved until 30,000 sheets in both the photoreceptors. A significant improvement was obtained by combining the metallic oxide, and as for the α-Si photoreceptor, unevenness in halftone density and image blur due to ozone did not occur after printing 300,000 sheets per one photoreceptor.

The same advantages can be obtained not only in the contact type charging roller described above, but also in a non-contact type charging roller. Furthermore, the amount of ozone generated in the charging member is larger in the non-contact type system than the contact type system, and thus significant advantage is obtained by applying the invention to the non-contact type charging roller.

The non-contact charging roller may have on both ends thereof rubber guide rollers, which are used in the contact charging roller described above. As for the material of the non-contact charging roller, a resin roller may be produced by molding and grinding a resin, such as ABS, having an electroconductive agent mixed therein and further having noble metal nanoparticles and a metallic oxide according to the invention mixed therein.

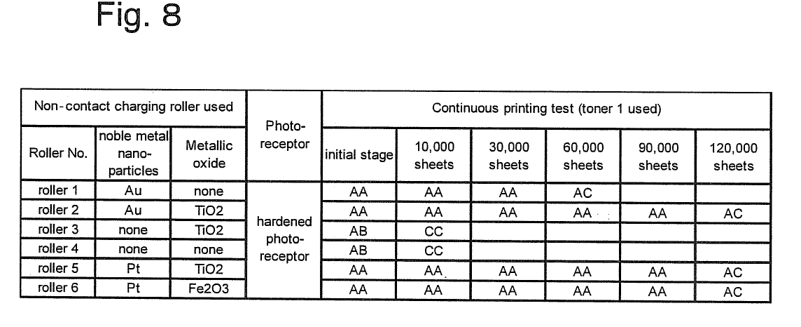

On both ends of the charging roller used in FIG. 7, guide rollers having a diameter that is larger by 50 μm than the charging roller are provided to form a gap of about 25 μm between the charging roller and the photoreceptor. The results of the test performed with the guide roller are shown in FIG. 8.

A hardened photoreceptor is used as the photoreceptor. When the invention is not applied, and the non-contact charging roller is used, image blur due to ozone is found after printing about 100 sheets, and images cannot be printed after printing 10,000 sheets. Accordingly, a problem due to ozone or the like is liable to occur when the charging roller is remote from the surface of the photoreceptor, as compared to the case where the charging roller is in contact with the photoreceptor. When the invention is applied, on the other hand, the service life can be prolonged with the non-contact type system as similar to the contact type system. The advantage of the invention is significantly obtained upon applying to a non-contact charging roller, as compared to a contact charging roller.

In the aforementioned examples, the cases where the invention is applied to a photoreceptor or a charging roller are described. However, the invention is not limited to a photoreceptor, but in general, the invention may be applied to a carrier that holds a latent image but does not have photosensitivity, i.e., an image bearing member.

In the invention, ozone can be efficiently decomposed by adding noble metal nanoparticles to the surface layer of the image bearing member, and the noble metal nanoparticles is optically transparent and maintains insulating property in a dark place. Furthermore, it is found that ozone can be decomposed with high efficiency by dispersing the noble metal nanoparticles in the charging member for charging the image bearing member. In the invention, the noble metal nanoparticles may be dispersed in the surface layer of the image bearing member, and simultaneously in the charging member for charging the image bearing member.

According to the methods, ozone can be decomposed at a position close to the generation source thereof, whereby not only the photoreceptor can be prevented from being deteriorated, but also the charging device itself can be prevented from being deteriorated, and thus it considerably contributes to enhancement of the service life.

Furthermore, as being different from the conventional case where the ozone problem is resolved by abrading the photoreceptor, deterioration can be largely reduced. Accordingly, in the invention, high image quality can be retained with a significantly reduced abrasion amount, thereby providing an image bearing member and an image forming apparatus having a long service life.

The effect of the noble metal nanoparticles is exhibited significantly in a state where they are in contact with the oxide particles, and therefore, titanium oxide, iron oxide or the like is preferably added in combination. By externally adding the oxide to the toner, the oxide passes through the cleaning part of the image bearing member to reach the charging member for the image bearing member, upon which the oxide is in contact with the noble metal particles exposed on the surface of the photoreceptor to decompose ozone effectively through the mutual action between them.

In an image forming apparatus without a cleaning blade for a photoreceptor, i.e., an image forming apparatus of so-called cleaning-less process, the external additive for the toner exhibits the advantages of the invention largely since the additive reaches the charging member further conspicuously, and the surface of the photoreceptor is hard to be abraded due to the absence of a blade, which provide weakness against ozone.

The noble metal nanoparticles used in the invention preferably have a diameter of about from 10 to 200 nm, and the metallic oxide used in the invention preferably has a diameter of about from 10 to 200 nm.

Obviously, many modifications and variations of the invention are possible in the light of the above teachings. It is therefore to be understood that within the scope of the appended claims, the invention may be practiced otherwise than as specification.

What is claimed is:

1. An image bearing member that holds an image, the image bearing member comprising noble metal nanoparticles dispersed in at least a surface of a resin layer of the image bearing member.

2. The image bearing member as claimed in claim 1, wherein a metallic oxide is dispersed along with the noble metal nanoparticles in at least a surface of the resin layer.

3. The image bearing member as claimed in claim 2, wherein the noble metal is platinum or gold.

4. The image bearing member as claimed in claim 3, wherein a metallic oxide is dispersed along with the noble metal nanoparticles in at least a surface of the resin layer.

5. The image bearing member as claimed in claim 4, wherein a surface of the image bearing member is subjected to a hardening treatment.

6. An image forming apparatus comprising:
a rotatable photoreceptor drum comprising an organic photoreceptor having a resin layer, and comprising noble metal nanoparticles dispersed in at least a surface of the resin layer,
a charging member that charges the organic photoreceptor,
an exposing member that selectively irradiates the organic photoreceptor, which is charged with the charging member, to form a latent image,
a developing member that develops the latent image, which is formed with the exposing member, with a toner, and
a transferring member that transfers a toner image, which is developed with the developing member, to a carrier.

7. The image forming apparatus as claimed in claim 6, wherein a metallic oxide is dispersed along with the noble metal nanoparticles in at least a surface of the resin layer.

8. The image forming apparatus as claimed in claim 6, wherein the noble metal is platinum or gold.

9. The image forming apparatus as claimed in claim 8, wherein a metallic oxide is dispersed along with the noble metal nanoparticles in at least a surface of the resin layer.

10. The image forming apparatus as claimed in claim 9, wherein a surface of the image bearing member is subjected to a hardening treatment.

11. The image forming apparatus as claimed in claim 10, wherein the resin layer contains a chain polymerizable functional group.

12. The image forming apparatus as claimed in claim 6, wherein light radiated on the organic photoreceptor in the exposing member has a wavelength of 600 nm or less.

13. A charging member for charging an organic photoreceptor of an image forming apparatus, the charging member comprising noble metal nanoparticles dispersed in at least in a surface of the charging member.

14. The charging member for an image forming apparatus as claimed in claim 13, wherein a metallic oxide is dispersed along with the noble metal nanoparticles in at least a surface of the charging member.

15. The charging member for an image forming apparatus as claimed in claim 13, wherein the noble metal is platinum or gold.

16. The charging member for an image forming apparatus as claimed in claim 15, wherein a metallic oxide is dispersed along with the noble metal nanoparticles in at least a surface of the charging member.

17. An image forming apparatus comprising:
a rotatable photoreceptor drum comprising an organic photoreceptor having a resin layer,
a charging member that charges the organic photoreceptor with a charging member comprising noble metal nanoparticles in at least a surface thereof,
an exposing member that selectively irradiates the organic photoreceptor, which is charged with the charging member, to form a latent image,
a developing member that develops the latent image, which is formed with the exposing member, with a toner, and
a transferring member that transfers a toner image, which is developed with the developing member, to a carrier.

18. The image forming apparatus as claimed in claim 17, wherein a metallic oxide is dispersed along with the noble metal nanoparticles in at least a surface of the charging member.

19. The image forming apparatus as claimed in claim 17, wherein the noble metal is platinum or gold.

20. The image forming apparatus as claimed in claim 19, wherein a metallic oxide is dispersed along with the noble metal nanoparticles in at least a surface of the charging member.
